(19) United States
(12) Patent Application Publication
(10) Pub. No.: US 2019/0252700 A1
(43) Pub. Date: Aug. 15, 2019

(54) Hydrogen-Producing Device and Operation Method of Hydrogen-Producing Device

(71) Applicant: Sawafuji Electric Co., Ltd., Gunma (JP)

(72) Inventor: Tomonori Miura, Gunma (JP)

(21) Appl. No.: 16/333,971

(22) PCT Filed: Oct. 13, 2017
(86) PCT No.: PCT/JP2017/037162

§ 371 Date: Mar. 15, 2019

(30) Foreign Application Priority Data
Nov. 18, 2016 (JP) 2016-224912

(51) Int. Cl. H01M 8/04225; H01M 8/0606; H01M 8/0612; H01M 8/04313; H01M 8/04746; H01M 8/04858; H01M 8/04302; B01J 19/08; C01B 3/04; C01B 3/22; C01B 3/50

(52) U.S. Cl. CPC H01M 8/04225; H01M 8/0606; H01M 8/0618; H01M 8/04313; H01M 8/04776; H01M 8/04932; H01M 2008/1095; B01J 19/08; C01B 3/047; C01B 3/22; C01B 3/501; H01M 2250/10; H01M 8/04302

(57) ABSTRACT

A hydrogen-producing device is provided which can start up without receiving an energy supply from the outside. This hydrogen-producing device 1 is provided with an input unit 11 which is connected to a hydrogen source 41, a reformer 12 which produces a hydrogen-containing gas, a hydrogen storage container 13, a fuel battery 15 which generates power using the hydrogen-containing gas, and a control unit 18. The hydrogen storage container 13 is connected to a fuel hydrogen supply path 16 for supplying hydrogen to the fuel battery 15, and to an external supply path 17 which supplies hydrogen to an external load 42. The control unit 18 stores a threshold value of the hydrogen-containing gas necessary for start-up of the fuel battery 15, and controls the amount stored in the hydrogen storage container 13 to be greater than or equal to the amount necessary for start-up of the fuel battery 15. Further, when starting up the hydrogen-producing device, the fuel battery 15 generates power by receiving a supply of the hydrogen-containing gas stored in the hydrogen storage container 13 and supplies power to the reformer 12 from a power supply path 30. The reformer 12 starts up and hydrogen is produced.

### FIELD OF THE INVENTION

The present invention relates to hydrogen-producing devices. In particular, the invention relates to a hydrogen-producing device which is capable of starting up and continuing hydrogen production without receiving an energy supply from the outside.

### DESCRIPTION OF THE RELATED ART

Hydrogen tends to be costlier to store and transport compared to other fuels. Because of this, there is an intrinsic demand for on-site production of hydrogen, by installing a hydrogen-producing device adjacent to a device that uses hydrogen, or incorporating a hydrogen-producing device in equipment that uses hydrogen.

A known hydrogen production method consists of decomposing a hydrogen source such as ammonia, urea, or a hydrocarbon gas to produce hydrogen. A device used for decomposing a hydrogen source is usually called a reformer. A reformer needs to be supplied with energy from the outside on start-up, and a hydrogen-producing device is thus normally connected to, for example, an external power supply to supply energy to the reformer on start-up. However, in cases where the supply of energy from the outside was cut off or stopped, such as during a power outage or a natural disaster, it was difficult to start up the hydrogen-producing device until the external energy supply was restored.

Storage batteries are known means for supplying energy necessary for start-up of hydrogen-producing devices during emergencies. However, storage batteries having enough capacity to start up a hydrogen-producing device are large and expensive, and therefore a factor driving up the size and cost of the hydrogen-producing device as a whole. Further, when using a storage battery as an emergency energy storage means, repeated charging and discharging gradually depletes the capacity of the storage battery, leading to the risk that the required electric power could not be supplied after a certain time of use.

Various techniques have been proposed for starting up a hydrogen-producing device without supplying energy from the outside. Patent Document 1 discloses a technique for reducing power consumption on start-up of a hydrogen-producing device that includes a power supply for autonomous start-up. Patent Document 2 discloses a technique for ensuring that the stopping period of a hydrogen-producing device does not overlap with a power outage period based on power outage information obtained in advance.

### PRIOR ART DOCUMENTS

### Patent Documents

Patent Document 1: Japanese Unexamined Patent Publication No. 2016-34881

Patent Document 2: Japanese Unexamined Patent Publication No. 2016-94328

### SUMMARY OF THE INVENTION

### Problem to be Solved by the Invention

Conventional hydrogen-producing devices with reformers could not be started up without being supplied with energy such as electric energy from the outside. This became a problem in that autonomous start-up was not possible during power outages or natural disasters. There was thus a need for technology that enables easy and certain start-up of a hydrogen-producing device even when energy cannot be supplied from the outside.

### Means for Solving the Problem

In order to overcome the aforementioned problem, the present invention provides a hydrogen-producing device capable of starting up without receiving an energy supply from the outside. The hydrogen-producing device according to the present invention includes an input unit which is connected to a hydrogen source and introduces a hydrogen-containing raw material, a reformer which decomposes the raw material introduced by the input unit to produce a hydrogen-containing gas, a hydrogen storage container which temporarily stores the hydrogen-containing gas produced by the reformer, a measurement unit which measures a storage amount of hydrogen-containing gas in the hydrogen storage container, a fuel battery that generates power using hydrogen-containing gas produced by the reformer and supplies power to the reformer, a fuel hydrogen supply path which supplies at least part of the hydrogen produced by the reformer to the fuel battery, an outside supply path which supplies part of the hydrogen produced by the reformer to the outside, and a control unit which receives measurement data from the measurement unit to control the amount of hydrogen-containing gas produced by the reformer, the storage amount of hydrogen-containing gas stored by the hydrogen storage container, and the amount of power generated by the fuel battery. The control unit of the hydrogen-producing device according to the present invention stores a threshold value of the measurement data corresponding to the minimum amount of hydrogen-containing gas necessary for start-up of the fuel battery, compares the received measurement data with the threshold value, and performs control to increase the storage amount of hydrogen-containing gas in the hydrogen storage container when the measurement data is below the threshold value. The fuel battery is characterized in that on start-up it uses the hydrogen stored in the hydrogen storage container to generate power and supplies power to the reformer.

The hydrogen-producing device according to the present invention includes a fuel battery (fuel cell) that uses a chemical reaction of hydrogen and oxygen to generate power. During normal operation, the hydrogen storage container that stores the hydrogen-containing gas supplied by the reformer always stores an amount of hydrogen-containing gas necessary for start-up of the fuel battery. When start-up of the hydrogen-producing device is required, power generation by the fuel battery is initiated by supplying the hydrogen-containing gas stored in the hydrogen storage container to the fuel battery. Further, hydrogen production by the reformer is initiated by supplying power from the fuel battery to the reformer. The fuel battery can use the hydrogen produced by the reformer to continue power generation and steadily supply the necessary energy to the reformer.

In the hydrogen-producing device according to the present invention, the output power of the fuel battery is preferably greater than the power consumed by the reformer. In addition, the operating temperature of the fuel battery of the hydrogen-producing device according to the present invention is preferably greater than or equal to the operating temperature of the reformer.

In the hydrogen-producing device according to the present invention, the reformer includes a plasma reactor for decomposing raw material and turning it into plasma, the plasma reactor having a raw material supply port and a hydrogen discharge port, a power supply for plasma generation that is supplied with power from the fuel battery, and a hydrogen separation unit that demarcates the hydrogen discharge port side of the plasma reactor. The hydrogen separation unit preferably separates hydrogen from the raw material turned into plasma in the plasma reactor, and transmits the hydrogen to the hydrogen discharge port side.

Further, the hydrogen separation unit of the hydrogen-producing device according to the present invention is preferably a hydrogen separation membrane connected to the power supply for plasma generation, which hydrogen separation membrane functions as a high-voltage electrode by being supplied with power and discharges electricity between the hydrogen separation membrane and a grounding electrode to turn the raw material into plasma.

In the hydrogen-producing device according to the present invention, the hydrogen-containing raw material is preferably ammonia or urea.

The present invention also provides an operating method of a hydrogen-producing device. The operating method of the hydrogen-producing device according to the present invention is applied to a hydrogen-producing device including an input unit which is connected to a hydrogen source and introduces a hydrogen-containing raw material, a reformer which decomposes the raw material introduced by the input unit to produce a hydrogen-containing gas, a hydrogen storage container which temporarily stores the hydrogen-containing gas produced by the reformer, a measurement unit which measures a storage amount of hydrogen-containing gas in the hydrogen storage container, a fuel battery that generates power using hydrogen-containing gas produced by the reformer and supplies power to the reformer, a fuel hydrogen supply path which supplies at least part of the hydrogen produced by the reformer to the fuel battery, an outside supply path which supplies part of the hydrogen produced by the reformer to the outside, and a control unit which receives measurement data from the measurement unit to control the amount of hydrogen-containing gas produced by the reformer, the storage amount of hydrogen-containing gas stored by the hydrogen storage container, and the amount of power generated by the fuel battery. In the operating method of the hydrogen-producing device according to the present invention, the control unit stores a threshold value of the measurement data corresponding to the minimum amount of hydrogen-containing gas necessary for start-up of the fuel battery, compares the received measurement data with the threshold value and performs control to increase the storage amount of hydrogen-containing gas in the hydrogen storage container when the measurement data is below the threshold value. The method is characterized in that it includes a step wherein the control unit, on start-up, supplies hydrogen from the hydrogen storage container to the fuel battery, a step wherein the fuel battery initiates power generation using the supplied hydrogen, a step wherein power generated by the fuel battery is supplied to the reformer, a step wherein the reformer produces hydrogen by decomposing the raw material and turning it into plasma, and a step wherein the produced hydrogen is supplied to the fuel battery to continue power generation.

### Effects of the Invention

The hydrogen-producing device according to the present invention is capable of starting up autonomously and producing hydrogen without receiving an energy supply such as electric energy from the outside. Moreover, the hydrogen-producing device according to the present invention is capable of starting up autonomously and producing hydrogen without a storage battery for start-up of the reformer.

Since the output power of the fuel battery of the hydrogen-producing device according to the present invention is greater than the power consumed by the reformer, the reformer can be reliably started up using only power supplied by the fuel battery. As a result, once the reformer has started up, it is possible for the reformer to provide a stable supply of hydrogen necessary for continued operation of the fuel battery, so that the fuel battery continues to generate power. In other words, the hydrogen-producing device according to the present invention is capable of autonomous operation in addition to autonomous start-up, thanks to the power supplied by the fuel battery that constitutes a part of the device.

Since the operating temperature of the fuel battery of the hydrogen-producing device according to the present invention is greater than or equal to the operating temperature of the reformer, heating means for the reformer and cooling means for the hydrogen-containing gas supplied from the reformer are not necessary. This allows for a simpler construction of the hydrogen-producing device as a whole, and allows for reduced power consumption. It also allows the system to be installed in a wider range of locations.

By configuring the reformer of the hydrogen-producing device according to the present invention as a plasma reformer including a plasma reactor, a power supply for plasma generation, and a hydrogen separation unit, it is possible to cause an electric discharge between the hydrogen separation membrane and a grounding electrode under room temperature and atmospheric pressure conditions to turn the hydrogen-containing raw material into plasma and thereby produce hydrogen-containing gas. Since the plasma reformer according to the present invention operates at room temperature, combining it with a solid polymer fuel battery having an operating temperature of 100° C. or less obviates the need for any heating or cooling means, which allows for a simpler construction of the system as a whole, and easier control of the reformer.

Since the hydrogen-producing device as a whole can have a simpler construction, and power consumption can be reduced, the hydrogen-producing device can be made cheaper and smaller.

### BRIEF DESCRIPTION OF THE DRAWINGS

FIG. 1 is a block diagram showing the configuration of the hydrogen-producing device according to an embodiment of the present invention.

FIG. 2 is a flowchart showing the start-up sequence of the hydrogen-producing device according to an embodiment of the present invention.

FIG. 3 is a flowchart showing the stop sequence of the hydrogen-producing device according to an embodiment of the present invention.

FIG. 4 is a schematic view of the vertical cross-section of the reformer according to an embodiment of the present invention.

FIG. 5 is a graph showing the relationship between the power consumption and hydrogen production amount of the reformer according to the Examples.

FIG. 6 is a graph showing the relationship between the hydrogen supply rate and amount of generated power of the fuel battery according to the Examples.

### DESCRIPTION OF THE EMBODIMENTS

Below is an itemized description of a preferred embodiment of the present invention.

(1) “Autonomous start-up” of the hydrogen-producing device according to the present invention means that the reformer and fuel battery can be started up without receiving electric energy or an equivalent energy supply from the outside, whereupon hydrogen production can be started and hydrogen supplied to the outside.
(2) The “hydrogen source” refers to a means for storing a hydrogen-containing raw material and supplying this substance as raw material to the hydrogen-producing device according to the present invention. More specifically, it refers to a storage container for a hydrogen-containing raw material, or a supply pipe in communication with this storage container. The substance stored or supplied by the hydrogen source is ammonia, urea, or a hydrocarbon gas such as methane or the like.
(3) The “reformer” refers to a device for producing hydrogen using a hydrogen-containing substance as raw material. The reformer according to a most preferred embodiment is a plasma reformer which includes a plasma reactor, a power supply for plasma generation, a hydrogen separation unit functioning as a high-voltage electrode, and a grounding electrode, the reformer turning the hydrogen-containing substance into plasma by causing an electric discharge between the electrodes, and allowing only hydrogen to pass through the hydrogen separation unit.
(4) As a reformer equivalent to a plasma reformer, a reformer which decomposes the hydrogen-containing substance using a catalyst to extract hydrogen, and a reformer combining a plasma reaction with a catalyst reaction, may be applied.
(5) The hydrogen-containing gas produced by the plasma reformer is a gas with hydrogen as its main constituent, and is particularly hydrogen of a high purity with a hydrogen concentration of 99.9% or higher.
(6) During normal operation, the control unit performs the following control:
Controls the amount of hydrogen-containing raw material that is introduced into the input unit.
Controls start-up and stopping of the reformer, and the amount of hydrogen-containing gas produced during operation.
Monitors and controls the storage amount of hydrogen-containing gas of the hydrogen storage container using the results of a comparison of the storage amount of the hydrogen storage container detected by a sensor with the stored threshold value.
Controls an amount of oxygen supplied to the fuel battery.
Controls the degree of opening of a first control valve connected to the hydrogen storage container to thereby control the amount of power generated by the fuel battery.
Controls the degree of opening of a second control valve connected to the hydrogen storage container to thereby control the amount of hydrogen supplied to the outside.
Monitors the amount of power generated by the fuel battery to control the amount of power supplied to the reformer.
   (7) When the control unit detects an anomaly such as a power outage or natural disaster, and has received a stop order from the outside, the control unit checks the storage amount of the hydrogen storage container and stops hydrogen production.
   (8) When the control unit has received a hydrogen production start-up order from the outside and a pre-planned time is reached, it executes the start-up sequence of the hydrogen-producing device.
   (9) A pressure gauge that measures the pressure of the hydrogen storage container can be applied as the measurement unit. Alternatively, a weight sensor that measures the weight of the gas stored in the hydrogen storage container may be used.
   (10) The fuel battery most preferably used in the hydrogen-producing device according to the present invention is a solid polymer fuel battery. Other types of fuel batteries can also be used.

An embodiment of the hydrogen-producing device according to the present invention is described below with reference to the drawings.

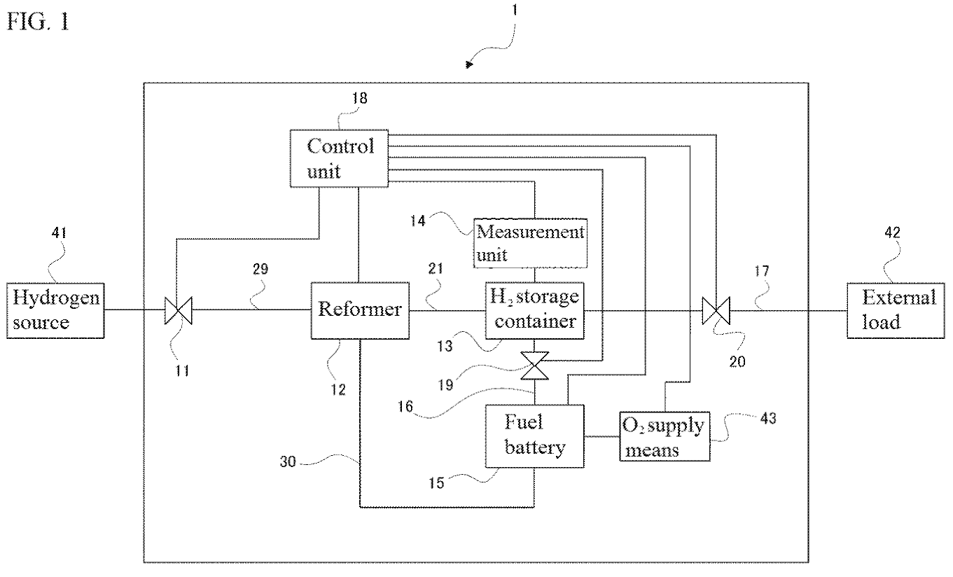

The hydrogen-producing device according to the present invention and the operating method of the device will now be described with reference to FIGS. 1 to 4. The hydrogen-producing device 1 shown in FIG. 1 includes an input unit 11, a reformer 12, a hydrogen storage container 13, a measurement unit 14, a fuel battery 15 (fuel cell 15), a control unit 18, and an oxygen supply means 43. The fuel battery 15 is connected to a power supply path 30 for supplying generated power to the reformer 12. The hydrogen storage container 13 is provided with two pipes for outputting hydrogen, and each pipe is provided with a control valve. The first output pipe is a fuel hydrogen supply path 16 in communication with the fuel battery 15, and is provided with a control valve 19. The second output pipe is an outside supply path 17 for supplying hydrogen to the outside, and is provided with a control valve 20. The control unit 18 is connected in communication respectively with the input unit 11, the reformer 12, the measurement unit 14, the fuel battery 15, the oxygen supply means 43, and the control valves 19 and 20.

The input unit 11 is connected to a hydrogen source 41 that stores and supplies a hydrogen-containing raw material, and introduces raw material received from the hydrogen source 41 into the reformer 12 via a raw material inlet path 29. The input unit 11 is preferably composed of a solenoid valve. The control unit 18 controls the degree of opening of the input unit 11 to control the amount of raw material introduced, and thereby controls the amount of hydrogen-containing gas produced by the reformer 12.

The reformer 12 decomposes a predetermined amount of raw material introduced via the raw material inlet path 29 to produce hydrogen-containing gas. The produced hydrogen-containing gas is temporarily stored in the hydrogen storage container 13 via a hydrogen supply path 21. The measurement unit 14 is connected to the hydrogen storage container 13, and measures the storage amount of hydrogen-containing gas in the hydrogen storage container 13. The measurement unit 14 is preferably a pressure gauge that measures the pressure inside the hydrogen storage container 13. The measured pressure is input into the control unit 18.

The hydrogen storage container 13 is provided with piping for outputting hydrogen in the form of the fuel hydrogen supply path 16 and the outside supply path 17. The fuel hydrogen supply path 16 in communication with the fuel battery 15 is provided with the control valve 19. The control unit 18 controls the degree of opening of the control valve 19 to control the amount of hydrogen-containing gas supplied to the fuel battery 15. The control unit 18 also controls the degree of opening of the control valve 20 provided to the outside supply path 17 to control the amount of hydrogen supplied to the outside and the storage amount of the hydrogen storage container 13. The control valves 19 and 20 are preferably composed of solenoid valves.

The fuel battery 15 uses hydrogen-containing gas supplied from the hydrogen storage container 13 and oxygen in air supplied from the oxygen supply means 43 to generate power. The fuel battery 15 is most preferably a solid polymer fuel battery with an operating temperature of 100° C. or less, and supplies generated power to the reformer 12 via the power supply path 30. The control unit 18 monitors the amount of power generated by the fuel battery 15 and controls the degree of opening of the control valve 19 and the amount of oxygen supplied from the oxygen supply means 43 in order to control a necessary amount of generated power. The oxygen supply means 43 is preferably an ordinary fan.

During normal operation, the control unit 18 performs the necessary control for achieving the two purposes of securing a required outside supply amount of hydrogen, and storing an amount of hydrogen-containing gas necessary for start-up of the fuel battery 15 in the hydrogen storage container 13. The control unit 18 stores the internal pressure in the hydrogen storage container 13 when it stores a minimum amount of hydrogen-containing gas necessary for start-up of the fuel battery 15 (hereinafter referred to as “start-up hydrogen amount”) as a threshold value. The control unit 18 then receives the measurement data from the measurement unit 14 and compares it with the threshold value. If it is determined based on the results of the comparison that the stored hydrogen-containing gas is below the start-up hydrogen amount, the control unit 18 controls the input unit 11 to increase the amount of raw material supplied to the reformer 12, thereby increasing the amount of hydrogen-containing gas produced by the reformer 12, so that the storage amount of the hydrogen storage container 13 becomes greater than or equal to the start-up hydrogen amount.

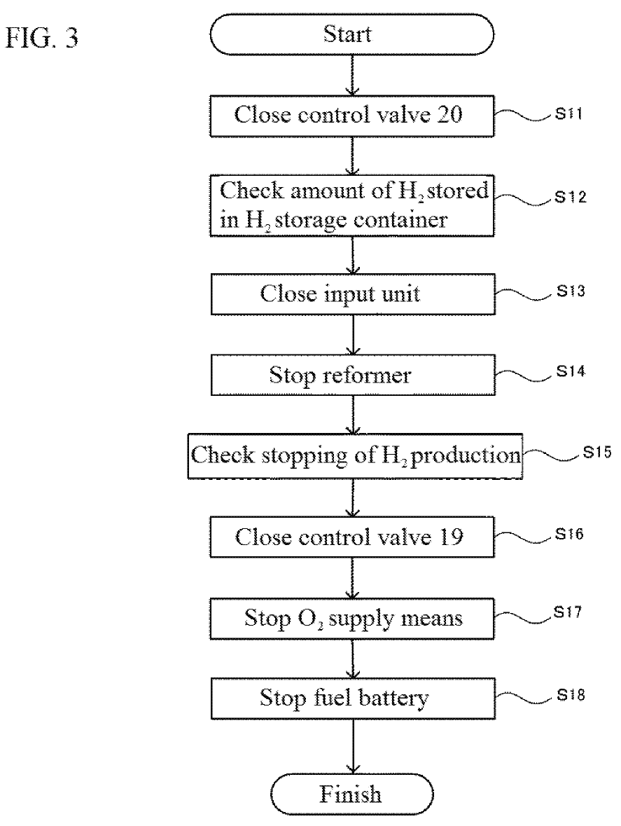

The stopping method of the hydrogen-producing device 1 will now be described with reference to FIG. 3. The series of steps for stopping the hydrogen-producing device 1 is initiated when a stop order is input into the control unit 18, and is entirely performed by the control of the control unit 18. Upon receiving the stop order, the control unit 18 closes the control valve 20 to stop hydrogen supply to the outside (Step S11). Next, the control unit 18 checks the measurement data of the measurement unit 14 and confirms that the start-up hydrogen amount is stored in the hydrogen storage container 13 (Step S12). Following confirmation, the control unit 18 closes the input unit 11 (Step S13), and stops the reformer 12 (Step S14). When the control unit 18 has confirmed that hydrogen production has stopped completely (Step S15), it closes the control valve 19 to seal the hydrogen storage container 13 and stop supply of hydrogen to the fuel battery 15 (Step S16). The control unit 18 further stops the oxygen supply means 43 (Step S17) and finally stops the fuel battery 15 (Step S18). By this stopping method, the hydrogen-producing device 1 is completely stopped with an amount of hydrogen-containing gas greater than or equal to the start-up hydrogen amount stored in the hydrogen storage container 13.

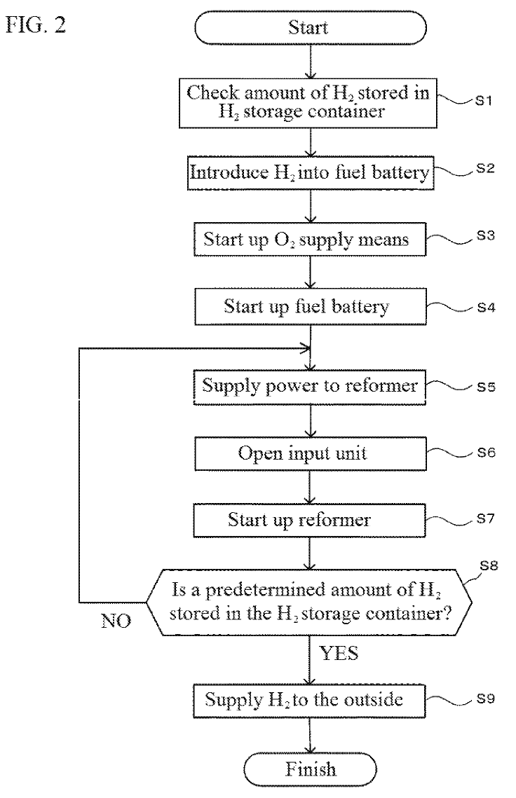

The start-up method of the hydrogen-producing device 1 will now be described with reference to FIG. 2. Start-up is performed entirely by the control of the control unit 18. The control unit 18 checks the measurement data of the measurement unit 14, and confirms that the start-up hydrogen amount is stored in the hydrogen storage container 13 (Step S1), then opens the control valve 19 to supply hydrogen from the hydrogen storage container 13 to the fuel battery 15 (Step S2). The control unit 18 then starts up the oxygen supply means 43 to supply oxygen to the fuel battery 15 (Step S3), whereby the fuel battery 15 starts up and power generation is initiated (Step S4). The generated power is supplied to the reformer 12 via the power supply path 30, and the reformer 12 starts up (Step S5). The control unit 18 then opens the input unit 11 to supply hydrogen-containing raw material to the reformer 12 (Step S6). Being supplied with power and raw material, the reformer 12 initiates hydrogen production (Step S7). The control unit 18 intermittently checks the measurement data of the measurement unit 14 again, and confirms that the start-up hydrogen amount is stored in the hydrogen storage container 13 (Step S8). When it is confirmed that the start-up hydrogen amount is stored, the result of Step S8 will be YES, and supply of hydrogen to the outside is initiated (Step S9).

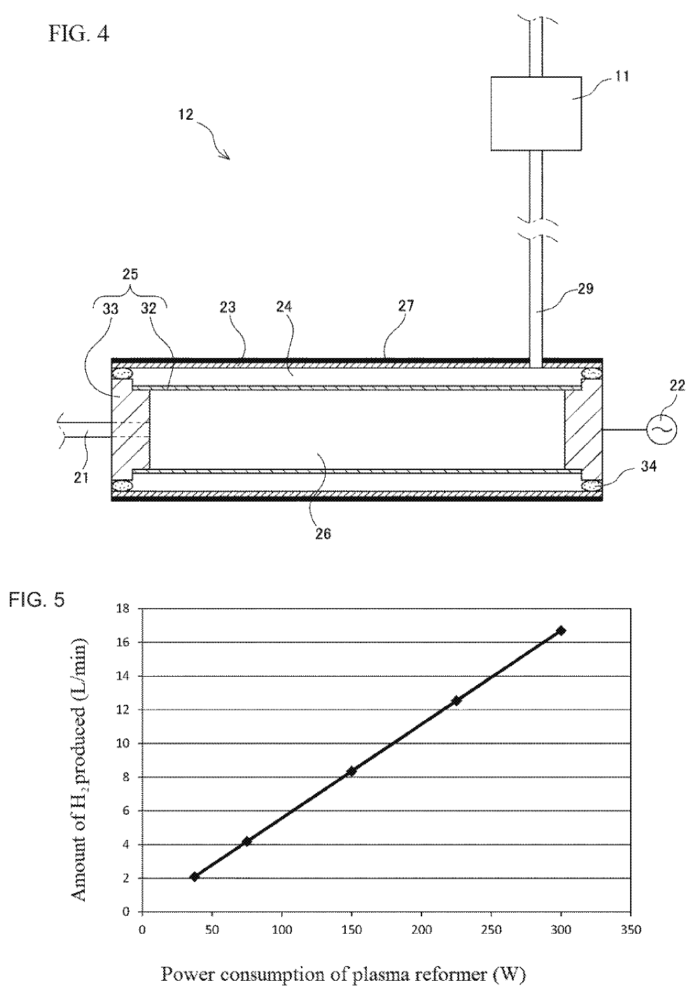

The reformer 12 preferably used in the present embodiment will now be described with reference to FIG. 4. The reformer 12 includes a plasma reactor 23, a high-voltage electrode 25 housed within the plasma reactor 23, and a grounding electrode 27 arranged in contact with the outside of the plasma reactor 23. The plasma reactor 23 is made of quartz, and is formed in a cylindrical shape. The high-voltage electrode 25 includes a cylindrical hydrogen separation membrane 32, and disc-shaped supports 33 that support both ends of the hydrogen separation membrane 32. The hydrogen separation membrane 32 is preferably a thin film of a palladium alloy.

The high-voltage electrode 25 is connected to a high-voltage pulsed power supply 22 which is connected to the fuel battery 15 via the power supply path 30, and is provided with a high voltage. O-rings 34 are fitted between the plasma reactor 23 and the supports 33 such that the hydrogen separation membrane 32 is arranged concentrically with the inner wall of the plasma reactor 23. As a result, a discharge space 24 in which a constant distance is maintained is formed between the inner wall of the plasma reactor 23 and the hydrogen separation membrane 32. In addition, on the inside of the hydrogen separation membrane 32, there is formed a sealed internal chamber 26 enclosed by the hydrogen separation membrane 32 and the supports 33. The grounding electrode 27 is arranged concentrically with the plasma reactor 23 and the hydrogen separation membrane 32. In the present embodiment, the most suitable raw material supplied from the hydrogen source 41 via the input unit 11 and the raw material inlet path 29 is ammonia gas. This ammonia gas is supplied to the discharge space 24 of the reformer 12.

The hydrogen separation membrane 32 and the grounding electrode 27 face each other, and the plasma reactor 23 made of quartz is arranged between them, so that the plasma reactor 23 acts as a dielectric, which allows for a dielectric barrier discharge to be generated by applying a high voltage to the high-voltage electrode 25 in the form of the hydrogen separation membrane 32. The power supply 22 that applies the high voltage to the high-voltage electrode 25 applies a voltage with an extremely short retention time of 10 μs.

Production of hydrogen using the reformer 12 is carried out by supplying ammonia gas to the discharge space at a predetermined flow rate, generating a dielectric barrier discharge between high-voltage electrode 25 in the form of the hydrogen separation membrane 32 and the grounding electrode 27, and generating atmospheric pressure non-equilibrium plasma of ammonia in the discharge space 24. The hydrogen gas generated from the atmospheric pressure non-equilibrium plasma of ammonia is separated by passing through the hydrogen separation membrane 32 and moving into the internal chamber 26. The hydrogen generated from the atmospheric pressure non-equilibrium plasma of ammonia is adsorbed by the hydrogen separation membrane 32 in the form of hydrogen atoms, which scatter as they pass through the hydrogen separation membrane 32, after which they recombine into hydrogen molecules and move into the internal chamber 26. In this way, only hydrogen is separated. The hydrogen that has moved into the internal chamber 26 is stored in the hydrogen storage container 13 via the hydrogen supply path 21 as high-purity hydrogen with a hydrogen concentration of 99.9% or higher.

### EXAMPLES

Below is shown an Example of autonomous start-up of the hydrogen-producing device 1 including the reformer 12 and the fuel battery 15. The present Example employs as the fuel battery 15 a solid polymer fuel battery having a start-up hydrogen amount of 50 liters (0.05 m³) at 0.1 MPa (1 standard atmosphere).

In the present Example, a pressure gauge is employed as the measurement unit 14 for measuring the storage amount of the hydrogen-containing gas in the hydrogen storage container 13. The control unit 18 stores a threshold value of pressure corresponding to the amount of hydrogen-containing gas necessary for start-up of the fuel battery 15. During hydrogen production, the control unit 18 monitors the measured results of the measurement unit 14, and performs feedback control of the amount of hydrogen-containing gas produced by the reformer 12 and the storage amount of the hydrogen storage container 13 using the results of a comparison of the stored threshold value with the measured results, and constantly stores hydrogen-containing gas corresponding to the hydrogen amount of 50 liters necessary for start-up of the fuel battery 15 in the hydrogen storage container 13.

The reformer 12 of the present Example is a plasma reformer which includes a plasma reactor 23, a high-voltage electrode 25 housed within the plasma reactor 23, and a grounding electrode 27 arranged in contact with the outside of the plasma reactor 23. An example of the relationship between the power consumed by the reformer 12 and the amount of hydrogen produced is shown in Table 1 and FIG. 5. The hydrogen volumes shown below are calculated based on standard conditions (1 standard atmosphere, 0° C.).

TABLE 1

| Power consumed by the plasma | Amount of hydrogen produced |
|---|---|
| reformer (Wh) | (L/min) |
| 37.5 | 2.09 |
| 75 | 4.18 |
| 150 | 8.35 |
| 225 | 12.53 |
| 300 | 16.70 |

As shown in Table 1 and FIG. 5, the plasma reformer 12 in the present Example can produce hydrogen in proportion to the supplied power. Specifically, when the raw material ammonia is supplied at 1.39 liters per minute (calculated based on standard conditions), 2.09 liters of hydrogen is produced per minute with a power consumption of 37.5 W.

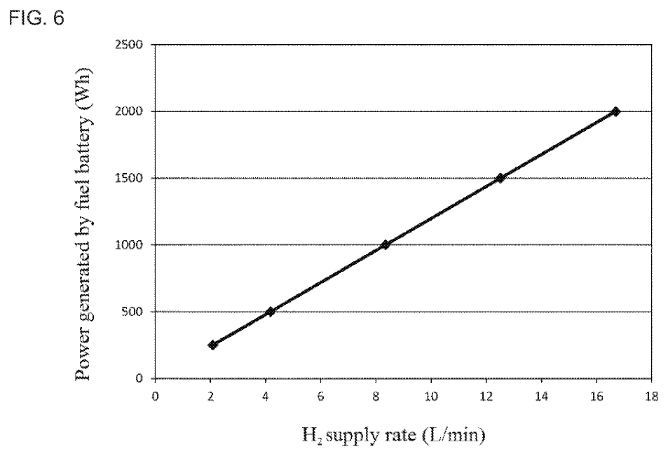

An example of the relationship between the amount of hydrogen supplied to the fuel battery 15 and the amount of power generated is shown in Table 2 and FIG. 6. The fuel battery 15 according to the present Example can generate power in proportion to the amount of hydrogen supplied.

| Power generated by the fuel | Amount of hydrogen supplied |
|---|---|
| battery (Wh) | to the fuel battery (L/min) |
| 37.5 | 0.31 |
| 75 | 0.63 |
| 150 | 1.25 |
| 225 | 1.88 |
| 300 | 2.51 |

The power generated by the fuel battery 15 is supplied to the reformer 12 via the power supply path 30. Receiving the power, the reformer 12 starts up, and the high-voltage pulsed power supply 22 applies a high voltage to the high-voltage electrode 25 to generate a dielectric barrier discharge between the high-voltage electrode 25 in the form of the hydrogen separation membrane 32 and the grounding electrode 27, thereby initiating hydrogen production. As is clear from the relationship shown in FIG. 5, the reformer 12 can produce 5.57 liters of hydrogen per minute with 100 W of power. The control unit 18 stores the produced hydrogen in the hydrogen storage container 13. Then, part of the stored hydrogen is supplied to the fuel battery 15 via the fuel hydrogen supply path 16 to continue power generation by the fuel battery 15. In this way, by starting up the fuel battery 15 and the reformer 12 and establishing a stable supply of power, hydrogen production can be continued.

The configuration and operation method of the hydrogen-producing device 1 described in the present Example may be altered as necessary. For example, in a variant of the reformer 12, the cylindrical hydrogen separation membrane 32 housed in the plasma reactor 23 may be grounded, and an electrode arranged in contact with the outside of the plasma reactor 23 may be connected to the high-voltage pulsed power supply 22. At this time, the hydrogen separation membrane 32 acts as the grounding electrode, and a dielectric barrier discharge can be generated like in the Example. Even in this case, the hydrogen separation membrane 32 is exposed to the plasma, and hydrogen can thus be separated.

In the present embodiment, an example was described in which the hydrogen storage container 13 and the control valves 19 and 20 were arranged in separate locations, but the control valves 19 and 20 can also be arranged at the outlets of the hydrogen supply paths, in one piece with the hydrogen storage container 13. In addition, the measurement unit 14 that measures the storage amount of the hydrogen storage container 13 may be another measurement device apart from a pressure gauge. For example, a weight sensor that measures the weight of the hydrogen may be used. The wiring and current voltage control means of the power supply path 30 for supplying power from the fuel battery 15 to the reformer 12 can also be altered depending on the overall arrangement and function of the device as a whole.

### DESCRIPTION OF THE REFERENCE NUMERALS

1 hydrogen-producing device

11 input unit

12 reformer

13 hydrogen storage container

14 measurement unit

15 fuel battery

16 fuel hydrogen supply path

17 outside supply path

18 control unit

19, 20 control valve

21 hydrogen supply path

22 high-voltage pulsed power supply

23 plasma reactor

24 discharge space

25 high-voltage electrode

27 grounding electrode

29 raw material inlet path

30 power supply path

32 hydrogen separation membrane

33 support

41 hydrogen source

42 external load

43 oxygen supply means

1. A hydrogen-producing device comprising:
an input unit connected to a hydrogen source and configured to introduce a hydrogen-containing raw material;
a reformer configured to decompose the raw material introduced by the input unit to produce a hydrogen-containing gas;
a hydrogen storage container configured to temporarily store the hydrogen-containing gas produced by the reformer;
a measurement unit configured to measure a storage amount of hydrogen-containing gas in the hydrogen storage container;
a fuel battery configured to generate power using hydrogen produced by the reformer, and supply power to the reformer;
a fuel hydrogen supply path configured to supply at least part of the hydrogen produced by the reformer to the fuel battery;
an outside supply path configured to supply part of the hydrogen produced by the reformer to the outside; and
a control unit configured to receive measurement data from the measurement unit and control the amount of hydrogen-containing gas produced by the reformer, the storage amount of hydrogen-containing gas of the hydrogen storage container, and the amount of power generated by the fuel battery,
characterized in that the control unit stores a threshold value of the measurement data corresponding to a minimum amount of hydrogen-containing gas necessary for start-up of the fuel battery, compares the received measurement data with the threshold value, and performs control to increase the storage amount of the hydrogen storage container when the measurement data is lower than the threshold value, and
the fuel battery on start-up uses hydrogen stored in the hydrogen storage container to generate power, and supplies power to the reformer.

2. The hydrogen-producing device according to claim 1, characterized in that the output power of the fuel battery is greater than the power consumed by the reformer.

3. The hydrogen-producing device according to claim 1, characterized in that an operating temperature of the fuel battery is greater than or equal to an operating temperature of the reformer.

4. The hydrogen-producing device according to claim 1, characterized in that the reformer comprises:
a plasma reactor for decomposing the raw material, the plasma reactor having a raw material supply port and a hydrogen discharge port;
a power supply for plasma generation receiving a power supply from the fuel battery; and
a hydrogen separation unit that demarcates the hydrogen discharge port side of the plasma reactor,
wherein the hydrogen separation unit separates hydrogen from the raw material turned into plasma inside the plasma reactor and transmits the hydrogen to the hydrogen discharge port side.

5. The hydrogen-producing device according to claim 4, characterized in that the hydrogen separation unit is a hydrogen separation membrane connected to the power supply for plasma generation, wherein the hydrogen separation membrane acts as a high-voltage electrode by being supplied with power, and causes an electric discharge between the hydrogen separation membrane and a grounding electrode to turn the raw material into plasma.

6. The hydrogen-producing device according to claim 1, characterized in that the hydrogen-containing raw material is ammonia or urea.

7. An operating method of a hydrogen-producing device, the device comprising:
an input unit connected to a hydrogen source and configured to introduce a hydrogen-containing raw material;
a reformer configured to decompose the raw material introduced by the input unit to produce a hydrogen-containing gas;
a hydrogen storage container configured to temporarily store the hydrogen-containing gas produced by the reformer;
a measurement unit configured to measure a storage amount of hydrogen-containing gas in the hydrogen storage container;
a fuel battery configured to generate power using hydrogen-containing gas produced by the reformer, and supply power to the reformer;
a fuel hydrogen supply path configured to supply at least part of the hydrogen produced by the reformer to the fuel battery;
an outside supply path configured to supply part of the hydrogen produced by the reformer to the outside; and
a control unit configured to receive measurement data from the measurement unit and control the amount of hydrogen-containing gas produced by the reformer, the storage amount of hydrogen-containing gas of the hydrogen storage container, and the amount of power generated by the fuel battery,
the method comprising the following steps:
the control unit stores a threshold value of the measurement data corresponding to a minimum amount of hydrogen-containing gas necessary for start-up of the fuel battery, compares the received measurement data with the threshold value, and performs control to increase the storage amount of the hydrogen storage container when the measurement data is lower than the threshold value,
on start-up, the control unit supplies hydrogen from the hydrogen storage container to the fuel battery;
the fuel battery initiates power generation by means of the supplied hydrogen;
the fuel battery supplies generated power to the reformer;
the reformer produces hydrogen by decomposing the raw material and turning it into plasma; and
produced hydrogen is supplied to the fuel battery to continue power generation.
